(19) United States
(12) Patent Application Publication
(10) Pub. No.: US 2021/0123174 A1
(43) Pub. Date: Apr. 29, 2021

(54) COMPOSITE

(71) Applicant: University of Cincinnati, Cincinnati, OH (US)

(72) Inventors: Andrew Steckl, Cincinnati, OH (US); Daewoo Han, Cincinnati, OH (US); Ashkan Tirgar, Cincinnati, OH (US)

(73) Assignee: University of Cincinnati, Cincinnati, OH (US)

(21) Appl. No.: 17/043,474

(22) PCT Filed: Dec. 30, 2017
(86) PCT No.: PCT/US2017/069142

§ 371 Date: Sep. 29, 2020

(51) Int. Cl. D04H 1/728; D04H 1/413; D01F 1/10; A23B 7/152; B01D 53/02; D01F 9/14

(52) U.S. Cl. CPC D04H 1/728; D04H 1/413; D01F 1/10; B82Y 30/00; B01D 53/02; D01F 9/14; A23B 7/152

(57) ABSTRACT

A composite comprising electrospun inorganic fibers and nanoparticles. The composite may carry a reagent, for example an oxidant. The composite may be formed by electro spinning a composition of a precursor material and nanoparticles to form a precursor composite followed by conversion of precursor fibers of the precursor composite to the inorganic fibers. The composite carrying a reagent may be used to absorb ethylene gas.

### BACKGROUND

Carbon nanofibers have been widely used in many applications such as electrode material for batteries^{16, 17}, electrochemical sensors,¹⁸ and supercapacitors¹⁹ because of their excellent electrochemical and mechanical properties.

Ethylene produced by plants can accelerate ripening of climacteric fruit, the opening of flowers, and the shedding of plant leaves. Use of sodium permanganate with a zeolite carrier for absorption of ethylene is disclosed in: http://www.thebluapple.com/docs/API_White_Paper.pdf

### SUMMARY

In a first aspect there is provided a composite comprising electrospun inorganic fibers and nanoparticles.

In a second aspect there is provided a method of absorbing a gas comprising the step of exposing a composite comprising electrospun inorganic fibers and nanoparticles to an environment containing the gas, wherein a gas absorber is supported on the composite.

In a third aspect there is provided a method of method of forming a composite comprising electrospun inorganic fibers and nanoparticles, the method comprising the steps of:

electrospinning an electrospinning composition comprising a precursor material and the nanoparticles to form a precursor composite comprising precursor material fibers and the nanoparticles; and

converting the precursor fibers to the inorganic fibers.

### DESCRIPTION OF THE DRAWINGS

Exemplary embodiments will now be described with reference to the drawings in which:

FIG. 1 is a flowchart of a method of forming a composite according to embodiments;

FIG. 2(a) is a SEM microphotograph of as-spun ANP-incorporated PAN polymer fibers at 1:1 w/w fibers;

FIG. 2(b) is a SEM microphotograph of the polymer fibers of FIG. 2(a) following heat treatment;

FIG. 2(c) is a SEM microphotograph of as-spun ANP-incorporated PAN polymer fibers at 0.2:1 w/w fibers;

FIG. 2(d) is a SEM microphotograph of the polymer fibers of FIG. 2(c) following heat treatment;

FIG. 2(e) is a SEM microphotograph of as-spun ANP-incorporated PAN polymer fibers at 2:1 w/w fibers;

FIG. 2(f) is a SEM microphotograph of the polymer fibers of FIG. 2(e) following heat treatment;

FIG. 3 is a plot of average ethylene absorption vs. time of ANP-incorporated CNF membrane and ANP-only;

FIG. 4 is a plot of average ethylene absorption vs. time of CNF membrane only;

FIG. 5(a) is a photograph of a film of an as-spun PVP/aluminum acetate membrane and its size change following calcination;

FIG. 5(b) is a SEM microphotograph of an as-spun PVP/aluminum acetate membrane;

FIG. 5(c) is a SEM microphotograph, at the same magnification as FIG. 5(b) of the polymer fibers of FIG. 5(b) following calcination;

FIG. 6 is a plot of average ethylene absorption vs. time of an alumina nanofiber;

FIGS. 7(a)-(d) are SEM microphotographs of PVP/aluminum acetate fibers embedded with ANPs with following amounts: 5% as-spun (a) and after calcination (c); 10% as-spun (b) and after calcination (d);

FIG. 8 shows plots of average ethylene absorption vs. time of alumina 5% and 10% ANP-incorporated alumina nanofiber membranes, ANP-incorporated CNF membranes, and alumina nanoparticles (ANP-Only);

FIG. 9 shows plots of ethylene absorption vs time for ANP-incorporated carbon nanofiber membranes, ANP 5% and ANP 10% incorporated alumina nanofiber membranes, alumina beads, and Blueapple® commercial absorber;

FIG. 10(a) shows photographs of a banana stored in a zip-lock bag containing 5% ANP-incorporated alumina nanofiber membrane after 1, 7, 10, and 14 days;

FIG. 10(b) shows photographs of a banana stored in a zip-lock bag with no absorber placed in the bag (control test) after 1, 7, 10, and 14 days;

FIG. 11(a) is a photograph of a PAN membrane after loading with PPM and vacuum drying;

FIG. 11(b) is a photograph of a PMMA membrane after loading with PPM and vacuum drying;

FIG. 12 is a plot of ethylene absorption vs. time for a PAN membrane loaded with PPM.

FIG. 13a schematically illustrates apparatus for coaxial electrospinning;

FIG. 13b schematically illustrates a cross-section of a nanofiber formed by coaxial electrospinning;

FIG. 14a schematically illustrates apparatus for triaxial electrospinning and

FIG. 14b schematically illustrates a cross-section of a nanofiber formed by triaxial electrospinning.

### DETAILED DESCRIPTION

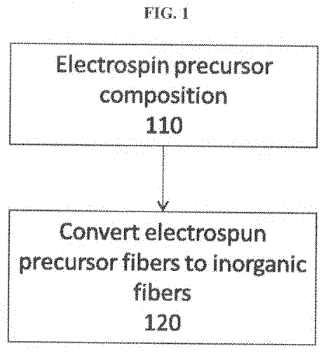

FIG. 1 is a flowchart of a method of forming a composite according to embodiments.

In step 110, an electrospinning composition comprising or consisting of a precursor material and nanoparticles is electrospun to form a precursor composite comprising precursor fibers and the nanoparticles.

In embodiments, the electrospinning composition may be a solution comprising one or more dissolved precursor material and comprising dispersed nanoparticles.

Optionally, the nanoparticles are the only material dispersed in the solution.

The solution may be treated before electrospinning to reduce aggregation of nanoparticles in the solution. Optionally, the solution is sonicated before electrospinning.

Optionally, the solution contains up to 20 weight %, optionally up to 15 weight %, of nanoparticles with respect to weight of the solvent.

Optionally, the solution contains at least 0.5 weight %, optionally at least 1 weight %, of nanoparticles with respect to weight of the solvent.

In embodiments, the electrospinning composition may be a melt comprising or consisting of molten precursor material and the nanoparticles.

The precursor material(s):nanoparticle weight ratio of the electrospinning composition may be selected according to the desired weight ration of the composite. Optionally, the precursor material(s):nanoparticle weight ratio of the electrospinning composition is in the range of about 0.1:1-1:0.1, optionally about 1:1.

Any suitable electrospinning apparatus may be used, including horizontal and vertical electrospinning apparatus. Electrospinning apparatus typically comprises a power supply, optionally 5-50 kV supply; a spinneret, for example a syringe needle; a spinneret pump; and a grounded collector. In operation, the electrospinning solution is extruded from the spinneret and electrospun precursor fiber is collected on the collector. The spinneret may be monoaxial, coaxial, triaxial or higher axial.

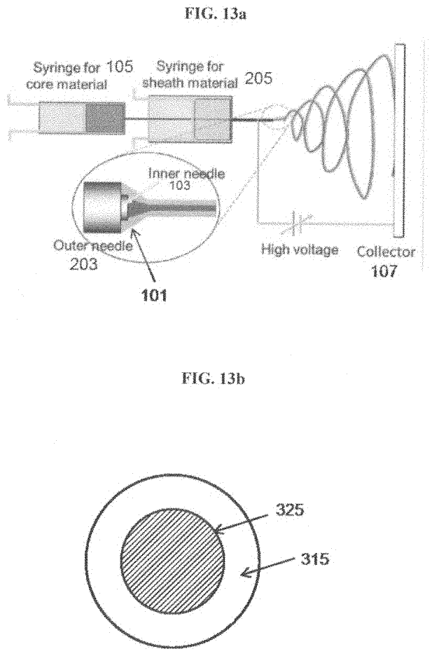

FIG. 13a schematically illustrates apparatus for coaxial electrospinning in which the spinneret 101 comprises a first, inner, needle 103 in fluid communication with a first syringe 105 containing a first electrospinning solution and a second, outer, needle 203 in fluid communication with a second syringe 205 containing a second electrospinning solution. The first needle is disposed in the second needle. In operation voltage is applied, the first electrospinning solution is delivered through the first needle, the second electrospinning solution is delivered through the second and electrospun fibers are collected at collector 107. With reference to FIG. 13b, material extruded from the first, inner, needle 103 forms a core 315 of the electrospun fibre and material extruded from the second, outer, needle 203 forms an outer sheath 325 of the electrospun fiber around the core.

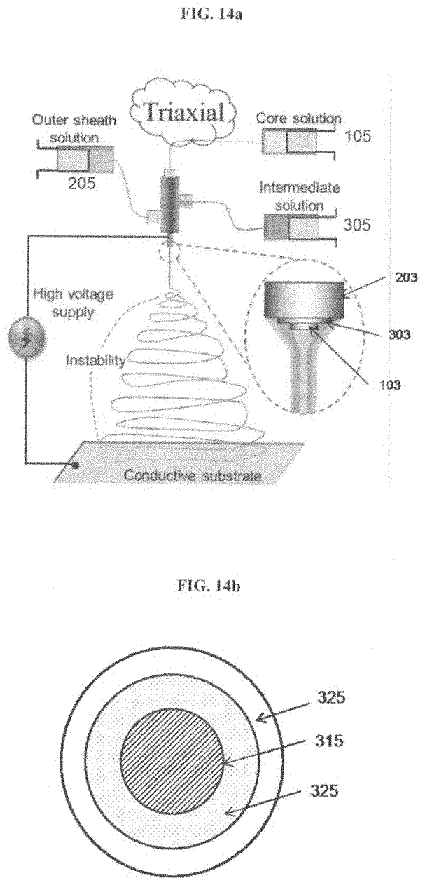

FIG. 14a schematically illustrates apparatus for triaxial electrospinning. The spinneret comprises first, second and third needles 103, 203 and 303 for delivery of first, second and third electrospinning solutions respectively in which intermediate needle 303 is between inner needle 103 and outer needle 203. With reference to FIG. 14b, material extruded from intermediate needle 303 forms an intermediate sheath layer 335 between the core 315 and the outer sheath 325.

The core may contain a compound which can escape from the nanofiber through the one or more sheath layers. The rate of release from the core may be controlled by selection of the material and/or thickness of the sheath layer or layers. In an embodiment, the core contains 1-methylcyclopropene (1-MCP). A nanofiber containing 1-MCP in a core thereof may be used in an environment in which harvested flowers or climacteric fruit is stored.

One or more sheath layers, preferably an outer sheath layer, may contain a material for absorbing a substance in the environment in which the nanofiber is located. In an embodiment, an outer sheath layer may contain a metal permanganate, preferably an alkali metal permanganate such as sodium or potassium permanganate.

A nanofiber may have a core containing a compound which can be released through the one or more sheath layers, for example 1-MCP, and a sheath layer containing a material for absorbing a substance in the environment in which the nanofiber is located, for example a metal permanganate.

In step 120, the precursor fibers are converted to the electrospun inorganic fibers. It will be appreciated that an “electrospun” fiber as described herein includes a fiber derived by conversion of a precursor fiber formed by electrospinning a precursor material.

In embodiments, the inorganic fibers are carbon fibers.

A composite containing carbon fibers may be formed by electrospinning a polymer solution having nanoparticles dispersed therein to form a composite of polymer precursor fibers and nanoparticles.

Exemplary polymers include, without limitation, polyacrylonitrile (PAN), polyacrylates, for example polymethylmethacrylate (PMMA), polycaprolactone (PCL), nylon, polyurethane (PU), polystyrene (PS), polylactic acid (PLA), cellulose, gelatin and collagen.

The polymer precursor fibers may be converted to carbon fibers by any suitable technique, preferably a carbonisation heat treatment. Carbonisation heat treatment is optionally at a temperature in the range of up to about 500-1500° C. Carbonisation heat treatment may be preceded by a stabilisation heat treatment at a lower temperature, for example a temperature in the range of up to about 100-400° C. Carbonisation heat treatment and stabilisation heat treatment may each independently be a ramped heat treatment.

Carbonisation heat treatment is preferably carried out in an inert environment, for example in an argon gas environment.

In embodiments, the inorganic fibers are metal oxide fibers, preferably alumina fibers.

A composite containing alumina fibers may be formed by electrospinning an aluminum salt solution having nanoparticles dispersed therein to form a composite of aluminum salt precursor fibers and nanoparticles. Preferably, the aluminum salt solution comprises a polymer dissolved therein. An exemplary polymer is polyvinylpyrollidone (PVP).

Preferably, the aluminum salt comprises a hydroxide anion or an organic anion including, without limitation, acetate, formate and propionate.

The aluminum salt precursor fibers may be converted to alumina fibers by any suitable technique, preferably a calcination treatment. “Calcination” as used herein means heating in an oxygen-containing atmosphere, for example heating in air. The calcination temperature is optionally in the range of about 500-1000° C. Calcination heat treatment is optionally a ramped heat treatment.

Preferably, a composite comprising metal oxide fibers as described herein does not contain electrospun carbon fibers.

Preferably, the composite as described herein contains only one form of electrospun fiber.

Conversion of precursor fibers into the inorganic fibers may result in a lower weight and/or diameter of the inorganic fibers as compared to the inorganic fibers.

Optionally, the inorganic fibers have a mean average diameter of 10 nm-10 microns, optionally 50 nm-2 microns, optionally 100 nm-500 nm.

It will be appreciated that an inorganic fiber as described herein may contain some organic material, for example residual polymer of a precursor fiber. Preferably, the inorganic fiber contains less than 10 wt %, optionally less than 5 wt % of organic material.

It will be understood that “organic material” as used herein includes carbon-containing compounds, such as polymers, but excludes carbon alone, which is an inorganic material as described herein.

Optionally, the weight of nanoparticles of the composite is greater than the weight of the inorganic fibers, optionally at least 1.5 times or 2 times the weight of the inorganic fibers.

Optionally, the nanoparticles have a number average diameter of less than 200 nm, optionally less than 100 nm, optionally at least 10 nm, as measured by dynamic light scattering. Optionally, the size and/or weight of the nanoparticles remain substantially unchanged by the conversion treatment, or a percentage change in size and/or weight of the nanoparticles following the conversion treatment is less than that of the fibers before and after conversion.

Optionally, the nanoparticles are alumina nanoparticles.

The composite may be in the form of a film. The film may have a thickness of less than about 10 mm, optionally about 100-500 microns. The film may be flexible. The film may be a porous membrane.

The composite may be loaded with a reagent following its formation. The reagent may adsorb or covalently bind to a surface of the composite. Some reagent may be absorbed into the composite.

The reagent may be applied to the surface of the composite from reagent solution followed by evaporation of the or each solvent.

In embodiments, the reagent is a gas absorbing material. A gas-absorbing material as described herein may react with a target gas. Optionally, the reagent is an oxidant, optionally a metal permanganate, preferably an alkali metal permanganate such as sodium or potassium permanganate. Optionally, the gas-absorbing material is an alkane, optionally cyclohexane. Optionally, the gas-absorbing material is TiO₂.

The composite carrying a reagent may be used to absorb ethylene in a location in which climacteric fruits are stored or transported including, without limitation, a warehouse, shop or vehicle. A composite carrying an ethylene absorbing reagent may be provided in a container containing climacteric fruit.

A membrane as described herein may be used in liquid treatment, e.g. for filtration of water or other liquids.

The composite described herein may be used or as a skin dressing for infections, e.g. bacterial or fungal infections.

The composite described herein may be used to carry a catalyst for use in a reaction vessel.

### EXAMPLES

### Materials

Polyacrylonitrile (PAN, Mw=150 kDa), polyvinylpyrrolidone (PVP, Mw=360 kDa), aluminum oxide nanopowder (diameter <50 nm), and aluminum acetate (dibasic) were purchased from Sigma-Aldrich (St. Louis, Mo.). N,N-dimethylformamide (DMF, 99.8% purity), and formic acid (88%), and ethanol (200 proof) were purchased from Fisher Scientific (Pittsburgh, Pa.). Potassium permanganate (PPM, ≥99.0%) was purchased from two different sources, Sigma-Aldrich and Alfa Aesar (Haverhill, Mass.). Activated alumina beads (⅛″ diameter) were purchased from Delta Adsorbents (Chicago, Ill.). A commercial ethylene absorber named Blueapple® Freshness Ball (refill kit) was used for comparison, which was purchased from Kitchen Kapers (Cherry Hill, N.J.). All materials were used as received without any further modification.

### Sample Preparation

Production of electrospun fibers was performed using a conventional vertical electrospinning setup composed of a high voltage power supply, syringe set placed on syringe pump, and conducting substrate. A high voltage supply was clipped between the collector and a 22 g blunt needle, which was used as a spinneret Luer-locked to a 5 mL plastic syringe containing the electrospinning solution. The distance between the spinneret tip and a grounded aluminum foil used for collection of nanofibers (collection distance) was 20 cm in all cases.

To produce carbon nanofibers, polymer membranes were first prepared by electrospinning PAN (9 wt. %) in DMF solution at a flow rate and a bias voltage of 1.5 mL/h and 18.5 kV, respectively. The polymer fibers then underwent a stabilization process at 260° C. (ramp rate of 2° C./min) for 3 hr, followed by carbonization at 1000° C. (ramp rate of 5° C./min) for 1 hr in the presence of argon gas with a constant flow rate of 2 standard cubic feet per hour (SCFH). ANP incorporated carbon nanofibers were achieved by electrospinning ANPs dispersed PAN/DMF solution and performing the sequential stabilization and calcination processes on ANP-incorporated PAN fibers. Up to 15 wt. % (with respect to solvent) of ANPs was very well dispersed in the PAN/DMF solution after stirring the solution for several hours. The resulting solutions were electrospun smoothly with a collection distance of 15 to 20 cm, flow rate of 0.5 to 1.2 mL/hr and bias voltage of 12 to 19 kV. Finally, a 2% w/v PPM aqueous solution was casted on the membranes using a pipette, and then the membranes were dried in vacuum oven at room temperature (RT). Stabilization and carbonization processes reduced the fiber diameter significantly, leading to a larger ratio between ANPs and carbon material than the ratio between ANPs and PAN polymer in the original membrane.

To make alumina nanofibers, aluminum acetate (AlAc) solution was prepared by dissolving 2.22 g of AlAc into the mixture of formic acid (FA, 2.22 g) and DI water (5.56 g) and then was blended homogeneously with 10 g of PVP 20 wt. % in ethanol solution.¹⁵ A syringe containing the solution was pumped at 0.7 ml/hr and fibers were obtained under 15 kV bias voltage within 20 cm collection distance. Electrospun membranes were then calcinated at 700° C. for 1 hr in air (ramp rate of 10° C./min), resulting in shrinkage and weight loss of membranes. In the final step, PPM aqueous solution (2% w/v) was casted drop-wise, and membranes were vacuum dried at RT. The same procedure was followed for making ANP-incorporated alumina nanofibers, except that the starting electrospinning solution contained a uniform dispersion of alumina nanoparticles. The weight of alumina nanoparticles added to the 20 g of total solution was 1 g or 2 g to obtain 5% or 10% w/w of ANP in the solution, hereinafter referred to as 5% or 10% ANP-incorporated alumina nanofibers.

For the results to be comparable, the amount of absorber materials used in each experiment was consistent as far as possible. In each case, ˜140 mg of carrier material loaded with ˜30 mg of PPM was used. All membranes were cut to have a similar apparent area of ˜28.1 cm² (mostly shaped as a 5.3 cm square). In the case of ANP-incorporated membranes, the carrier weight is the total weight of nanoparticles and fiber material together. Alumina beads and nanoparticles were also weighed to be ˜140 mg before being loaded with PPM. The concentration of PPM aqueous solution varied based on the solution uptake capacity of each carrier, leading to 2% w/v and 5% w/v PPM solutions be used for membranes and alumina beads, respectively. 1.5 mL of 2% PPM solution was loaded on membranes, while the PPM loading of alumina beads was performed by repeating three times of loading and vacuum drying processes with a higher concentration of PPM solution (5% w/v) due to the limited water uptake capacity of alumina beads. The amount of Blueapple® absorber used in gas experiments was determined to be 190 mg, which is 20 mg more than the weight of PPM loaded membranes or beads after complete drying. All as-spun membranes have a size of 10×10 cm² before any heat treatment. Each case was performed at least two times to evaluate the reproducibility.

### Fiber Morphologies

Scanning electron microscopy (SEM) was performed (EVEX SX-30 mini-SEM) to observe the fiber morphology and structure. To provide the required sample conductivity for SEM imaging, insulating samples were coated with a very thin (<10 nm) gold layer (Denton Vacuum Desk II sputtering system) at 50-60 mTorr pressure for 50 seconds.

### Ethylene Absorption Kinetics on Membranes

Ethylene level was monitored using F950 three gas analyzer (Felix Instruments, Camas, Wash.). This analyzer uses an electrochemical sensor for detection of ethylene and has a fine resolution, low detection limit, and wide detection range of 0.1 ppm, 0.2 ppm, and 0-200 ppm, respectively. The gas is pumped into the analyzer's sensor at an average flow rate of 70 mL/min. To measure ethylene absorption capability of samples, gas sealed bags were prepared by incorporating a rubber septum used as a gas injection port and for inserting the analyzer probe into the bags. Gas sealed bags were filled with ˜3 L of air, and 60 μL of pure ethylene gas was injected into the sealed bag using Hamilton gas-tight sample-lock syringe. After waiting a few minutes to allow the ethylene to spread uniformly inside the bag, the analyzer probe is inserted into the bag and the ethylene level analysis starts. It usually takes ˜3 minutes for the ethylene level to reach a plateau in the range of 18 to 23 ppm. During this time, the absorber inside the bag was kept isolated from the ethylene/air by pressing it in the corner of the bag. After that, the isolated membrane was released and started to interact with the gas inside the bag. The experiment time was usually limited to ˜40 minutes as the analyzer had nearly depleted the air inside the bag. Plots are obtained by averaging datasets from two or three runs of each experiment.

### Example 1

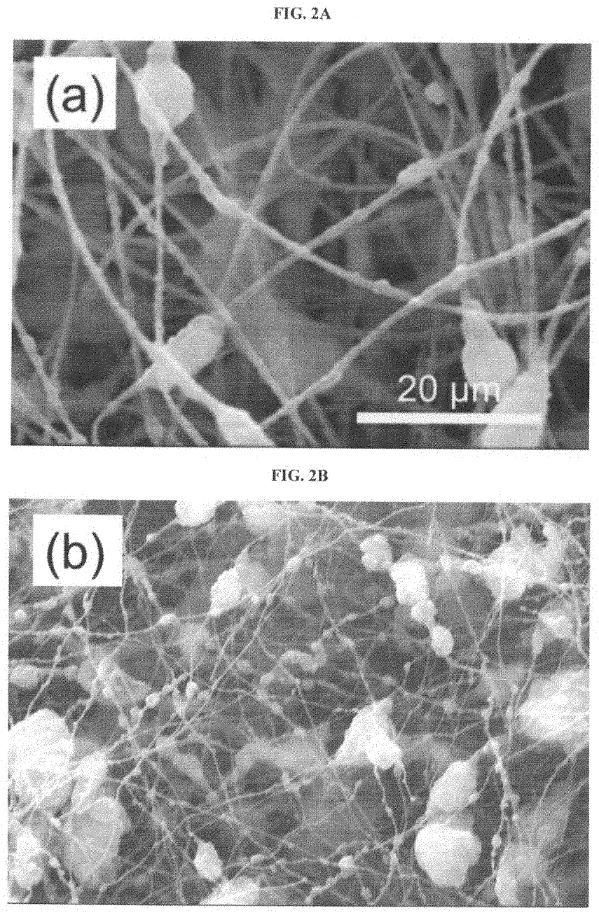

Carbon nanofibers were impregnated with alumina nanoparticles by electrospinning a dispersion of ANPs (9 wt. %) in the PAN (9 wt. %)/DMF solution. ANPs show a stable uniform dispersion in solution, and thus it was possible to obtain PAN fibers accommodating ANPs on the surface of and inside fibers, as shown in FIG. 2a. The heat treatment used to convert ANP-incorporated PAN to carbon materials reduced the fiber diameter as shown in FIG. 2b and decreased the weight of the membrane to ˜63% of the starting weight on average for seven fabricated membranes. The area of the membrane decreased to ˜42% of the starting area, from 10×10 cm² as-spun membrane to a 6.5×6.5 cm² carbon membrane. After carbonization, the ANPs become more exposed to the surface of fibers as a result of reduction in fiber diameter. Occasional aggregations along the fibers are observed. This aggregation of nanoparticles may adversely affect the absorption capacity of membranes, but can be resolved with more individually dispersed ANPs in solution achieved by high power sonication. Assuming the weight of ANPs remains constant during the heat treatment process, the weight change of the membranes can be attributed to weight loss of the fibers. This results in an increase in the weight ratio of ANPs to carbon fiber material from 1:1 to 3.57:1. While carbon nanofibers do not make a significant impact on the final weight of the absorber material, their strength at relatively low weight is sufficient to produce a durable and flexible scaffold for the nanoparticles. This allows the transformation of ANP absorber from the powder form to the easy handling membrane form that can provide uniform absorption all around it.

FIGS. 2c-2f show similar effects upon heating of electrospun ANP/PAN composites. Thus, a starting ANP:PAN weight ratio of 0.2:1 becomes a 0.5:1 ANP:CNF weight ratio as shown in FIGS. 2c and 2d respectively, and a starting ANP:PAN weight ratio of 2:1 becomes a 4.7:1 ANP:CNF weight ratio as shown in FIGS. 2c and 2d respectively

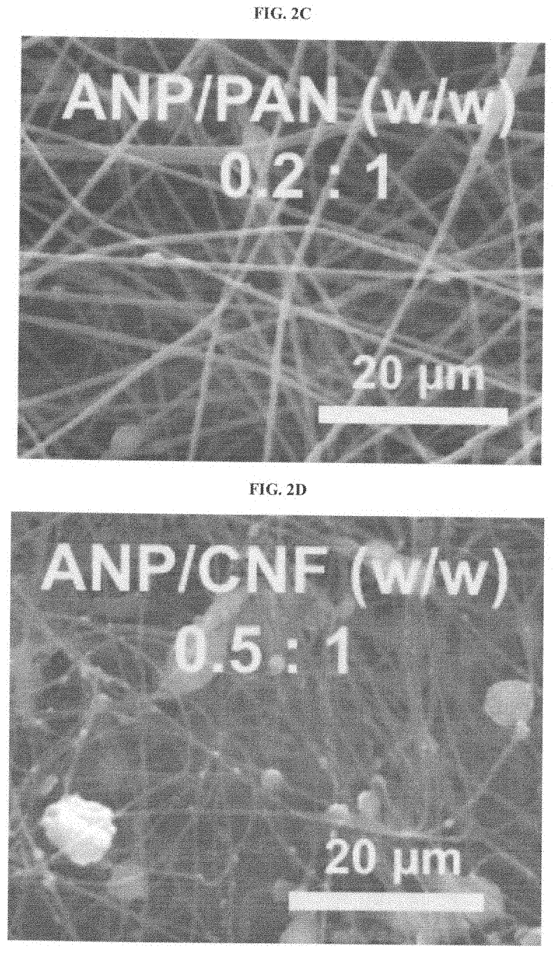

Gas experiments were performed with ANP-incorporated carbon nanofiber membranes weighing 140 mg to which 30 mg of PPM are added. The results shown in FIG. 3 indicate the efficiency of ANP-incorporated CNF membranes by absorbing 13.6% of initial ethylene amount in the first 12 minutes. As a comparison, alumina nanoparticles loaded with PPM but without the carrier membrane were prepared. The same amount of carrier material (140 mg) and PPM salt (30 mg) was used for both cases. Error bars for two repeated tests with activated ANP-only are not shown in FIG. 3 since the absolute value of difference between two curves falls below 0.8% at all points after releasing the absorbers. The two curves shown in this figure reveal comparable ethylene absorption from powder and membrane for the first 10-15 min.

### Comparative Example 1

For the purpose of comparison, ethylene absorption was measured using a 6×6 cm² carbon nanofiber membrane weighing 120 mg loaded with ˜175 mg PPM but without ANPs incorporated into the membrane.

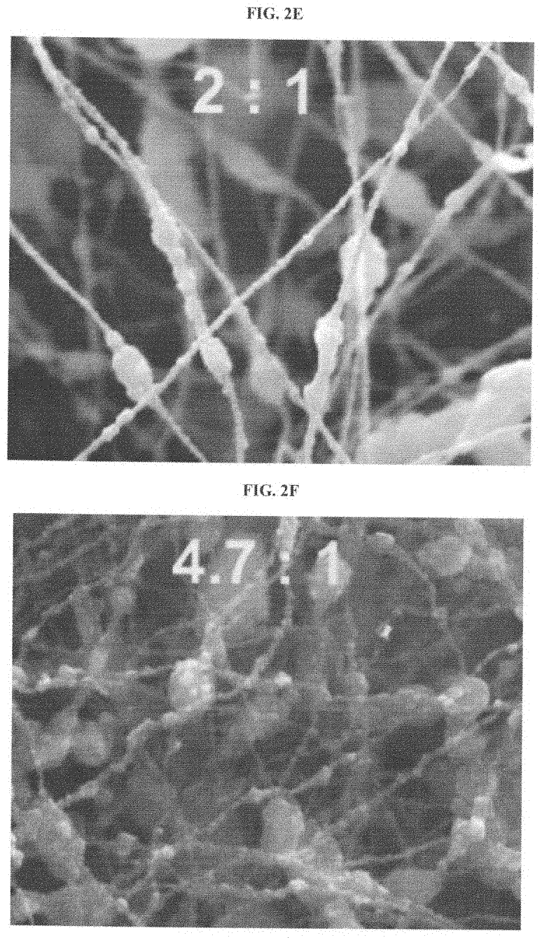

The results shown in FIG. 4 demonstrate a very small drop in the ethylene level followed by a gradual increase of the signal to the initial value. The PPM loaded carbon nanofibers release purple color in DI water even after going through the gas absorption test. This shows that PPM is present on/inside the fibers but is not working effectively in absorbing the ethylene. Considering the significant amount of PPM loaded on the membrane, and without wishing to be bound by any theory, the PPM may have been crystalized on the carbon fibers leading to loss of its surface area. The small drop in the signal may be due to adsorption (rather than absorption) of ethylene by the carbon fibers^{2,3} followed by gradual release of the adsorbed molecules.

### Comparative Example 2

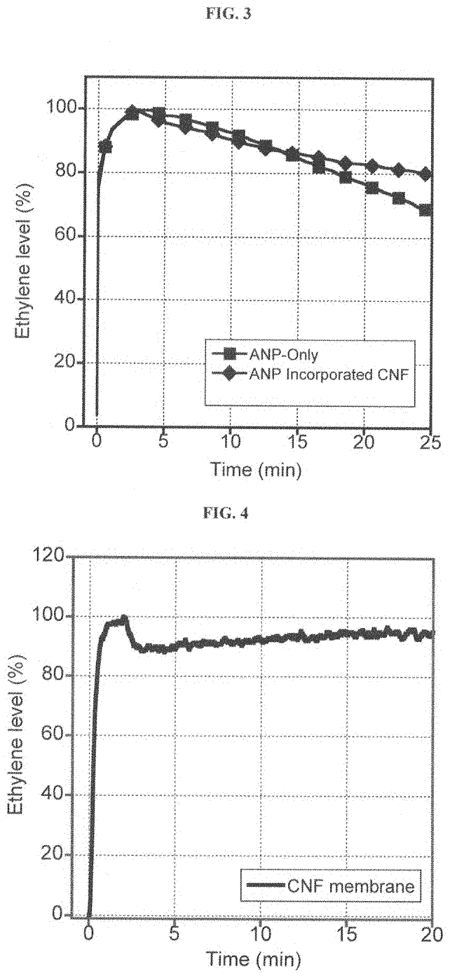

Alumina nanofibers were prepared by electrospinning followed by calcination as described above under “Sample preparation”. Photos of as-spun and calcinated fibers in FIG. 5a demonstrate shrinkage of the membrane causing ˜50% reduction in the size and 79-80% reduction in the weight of seven membranes investigated. SEM photos of fibers shown in FIGS. 5b and c indicate a 795 nm diameter for as-spun fibers versus a 440 nm diameter for alumina nanofibers.

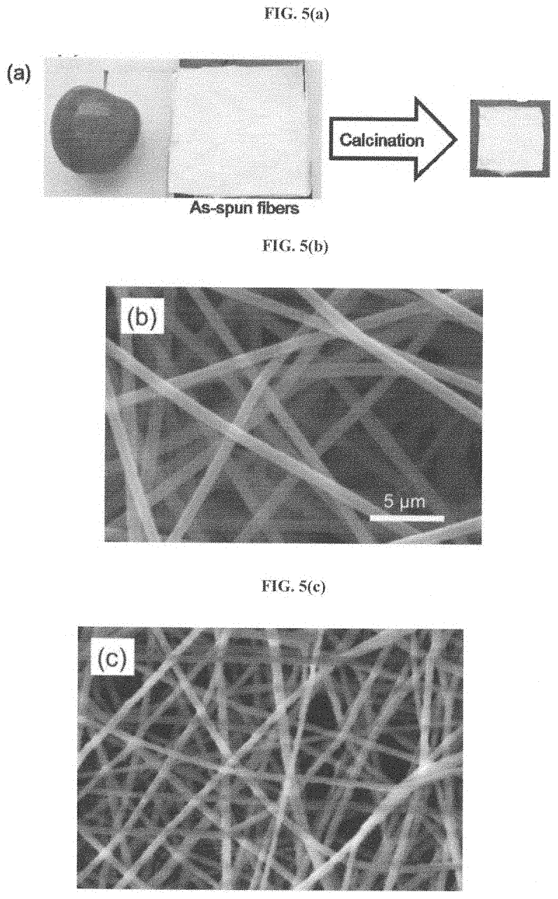

Several experiments were conducted to test the absorption of ethylene from PPM-loaded alumina nanofiber membranes. The absorption profile is shown in FIG. 6, but the error bars are not included because the absolute value of difference between the results was below 0.4% at all points after releasing the membranes. Negligible absorption was observed during the first 20 min after release of the membrane, followed by only 4.3% drop in ethylene level at the end of the 40-minute test period. Without wishing to be bound by any theory, this may be due to lack of enough functional hydroxyl groups on the surface of alumina fibers that can bind with PPM salt ions.²⁰ In fact, crystalized chunks of PPM salt incapable of binding to alumina fibers can be observed on PPM-loaded alumina nanofiber membranes after drying.

### Example 2

ANPs were incorporated into alumina nanofibers using a similar procedure to that used to fabricate ANP-incorporated carbon nanofibers described with reference to Example 1, by dispersing alumina nanoparticles in the electrospinning solution. The ANP-incorporated alumina nanofibers show only a few salt crystals, indicating a higher binding affinity between fiber material and PPM salt. This is also confirmed from the stronger purple color of ANP-incorporated alumina nanofiber membrane compared to alumina nanofiber membrane when they have the same weight, size, and loaded PPM weight.

5% and 10% ANP-incorporated alumina nanofiber membranes show ˜72% and 64% area reduction after calcination, respectively, which is slightly less than the 75% area reduction observed in pure alumina nanofibers. As expected, incorporation of nanoparticles into alumina fibers reduces weight loss of membranes to ˜65% for 5% ANP and ˜55% for 10% ANP membranes. This weight loss is much less than the 80% weight loss of the pure alumina nanofiber membranes and can be attributed to the fact that alumina nanoparticles do not lose weight during heat treatment process while the PVP component of the as-spun fibers evaporates and the AlAc part reacts with oxygen in air at high temperatures to form aluminum oxide.

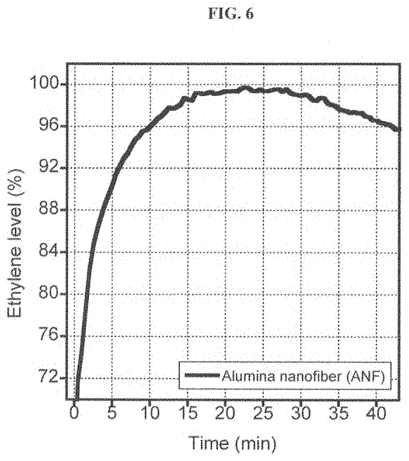

SEM photos in FIG. 7 show the alumina nanofiber morphologies before and after calcination. These photos reveal that as-spun fibers have a uniform diameter and the nanoparticles are well distributed inside the fibers with some aggregations protruded from the fibers. After calcination, the diameter of fibers decreases and more nanoparticles become exposed to the surface that makes the aggregations more evident. Besides, the as-spun fibers in FIGS. 7a and b, obtain a wavy structure after calcination shown in FIGS. 7c and d. This change of morphology can be attributed to the effect of alumina nanoparticles present in the fibers because, as shown in FIGS. 5b and c, the same linear fiber structure was shown before and after calcination of alumina fibers with no nanoparticle incorporated.

The ANP-incorporated alumina nanofibers were fabricated at weight ratios of 5:11.1 and 10:11.1 between ANPs and alumina precursor, leading to more ANPs being embedded in the latter. The prepared 10% ANP-incorporated alumina nanofiber membrane contains ˜28.5 mg more ANPs compared to the 5% ANP-incorporated alumina nanofiber membrane. That will have noticeable effect on the properties of fibers because the membrane containing more ANPs possesses a higher solution uptake capacity, ˜8% less area reduction, and ˜10% less weight loss. The SEM photos of alumina fibers impregnated with 5% ANP and 10% ANP shown in FIGS. 7c and d confirm the presence of more nanoparticles and more aggregations along the fibers with higher density of incorporated nanoparticles. The lower mechanical integrity of 10% ANP incorporated alumina fibers compared to its 5% ANP counterpart can be attributed to the smaller diameter of alumina nanofibers in the case of 10% ANP as can be seen in FIGS. 7c and d. Without wishing to be bound by any theory, the 10% less weight loss of fiber membrane with the higher ANP concentration may be due to the higher ratio between alumina nanoparticles, keeping their weight throughout calcination process, and fiber material that lose weight during conversion from AlAc/PVP material to aluminum oxide.

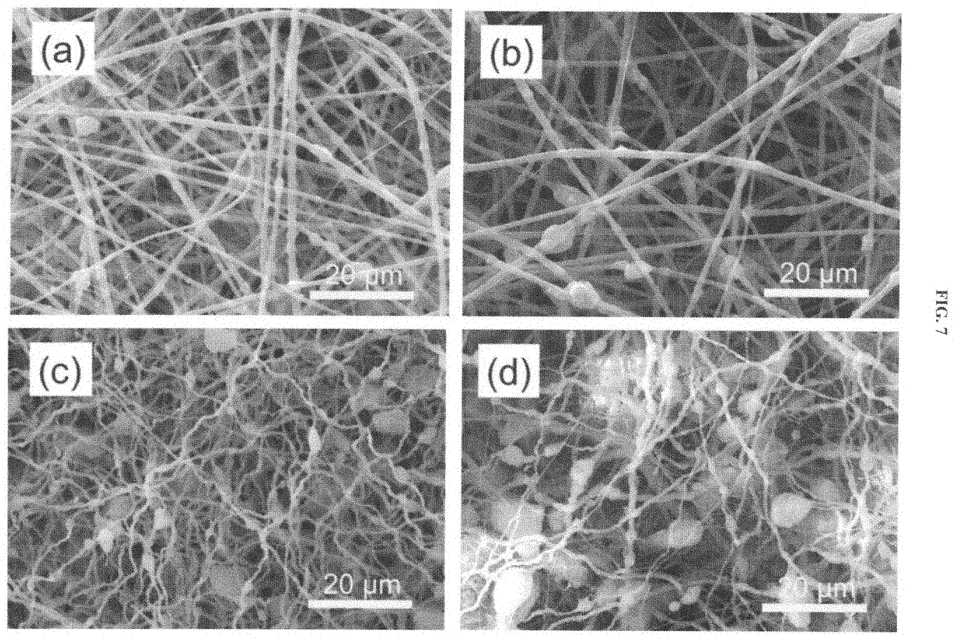

Gas experiments were performed with 5% and 10% ANP-incorporated alumina nanofibers weighing 140 mg and loaded with 30 mg of PPM. The superior performance of these membranes compared to previous carriers in activating the salt absorber is demonstrated in FIG. 8. The error bars presenting the maximum and minimum of ethylene level at each data point are small enough to indicate reasonable reproducibility. For 5% and 10% ANP-incorporated alumina nanofibers, the results in FIG. 8 show an ethylene level reduction of 39% and 51% at 15 min increasing to 54% and 74% ethylene reduction at 25 min, respectively. The two “bumps” on the curves for ANP-incorporated ANF membranes appear when the opposite side of the bag came in contact with the probe tip and caused blocking. The brief clogging of the ethylene analyzer probe usually causes a small peak that lasts for a few minutes if it is not resolved. Based on these results, it is feasible to tune the ethylene absorption capacity and kinetics of our ANP incorporated ANF membranes simply by controlling the weight ratio between ANPs and alumina fiber material. Further, a comparison of ethylene absorption between alumina (10% ANP-incorporated ANF) and carbon nanofiber incorporating a roughly equal amount of ANPs (˜100-110 mg) indicates the carrier material also plays a role in ethylene absorption characteristics. The ANP-incorporated alumina nanofibers even outperform powder-form of alumina nanoparticles (ANP-Only), which can be attributed to the larger surface area of alumina nanoparticles and highly porous network as result of larger spacing between particles provided by the membrane.

Comparison with Blueapple® and Alumina Beads

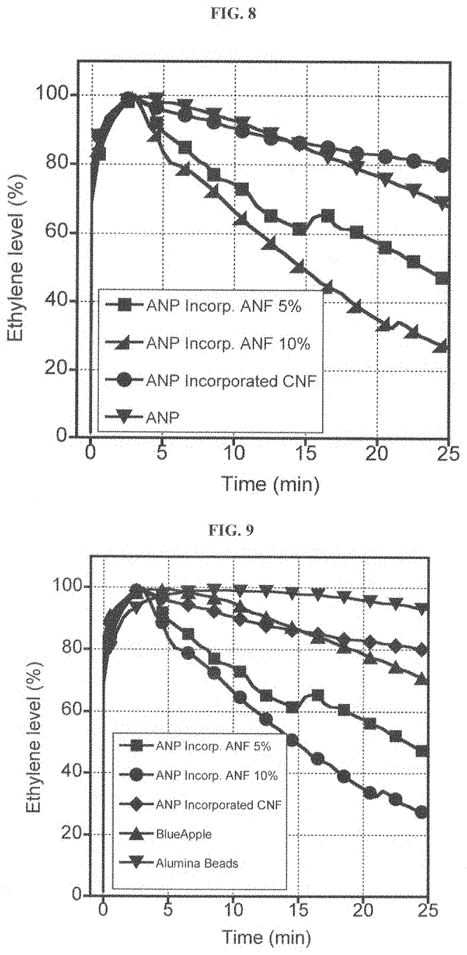

The performance of ANP-incorporated carbon and alumina nanofiber membranes was compared with a similar weight of commercially available Blueapple® absorber (190 mg) and 140 mg alumina beads (⅛″ diameter) loaded with 30 mg of PPM. Each experiment with either Blueapple® or alumina beads was performed three times, and the average and range of results plotted in FIG. 9 show a satisfactory reproducibility. The results in FIG. 9 demonstrate higher absorption efficiency of PPM on ANP incorporated alumina fiber membranes compared to the Blueapple® absorber and alumina beads.

Summary of results in Table 1 shows that Blueapple® beads, compared to alumina beads, absorb 4% and 17.4% more ethylene at 10 and 20 minutes, respectively. On the other hand, ANP incorporated carbon nanofiber membrane and Blueapple® absorber have a comparable performance by membrane absorbing more ethylene up to 15 minutes before the Blueapple® starts to overtake due to its higher rate of absorption. Finally, both 5% and 10% ANP incorporated alumina nanofiber membranes possess a significantly higher absorption capacity than the other absorbers. For instance, ANP (5% and 10%)-ANF membranes have absorbed 46.3% and 65% of ethylene at 20 min, respectively. However, the Blueapple® absorber has absorbed only 21.7% at 20 min, which is between one half and one third of the ethylene amount absorbed by ANP-ANF membranes. Moreover, the absorption capacity and the rate of absorption from these membranes that can be controlled by controlling the concentration of ANPs incorporated into the fibers. Another feature of absorption from ANP-ANF membranes is the relatively higher absorption of ethylene during the first three minutes after releasing the membranes. This property can be very useful in situations where targeted fruits or vegetables are in the stage of their ripening process that is associated with burst ethylene production¹. In such cases, the higher initial ethylene absorption from ANP-ANF membranes may first absorb the high level of ethylene accumulated around the products and then control the continuous production of ethylene through its large capacity and high absorption rate.

TABLE 1

| | 5 min | 10 min | 15 min | 20 min | 25 min |
|---|---|---|---|---|---|
| ANP incorp. CNF | 95.7 | 90.3 | 86 | 83 | 80 |
| 5% ANP incorp. | 89.3 | 74.3 | 61.7 | 53.7 | 46.7 |
| ANF | | | | | |
| 10% ANP incorp. | 83.4 | 66.3 | 49.3 | 35 | 27 |
| ANF | | | | | |
| alumina beads | 97.7 | 99 | 98 | 95.7 | 93 |
| Blueapple ® | 99.3 | 95 | 86 | 78.3 | 70.3 |
| absorber | | | | | |

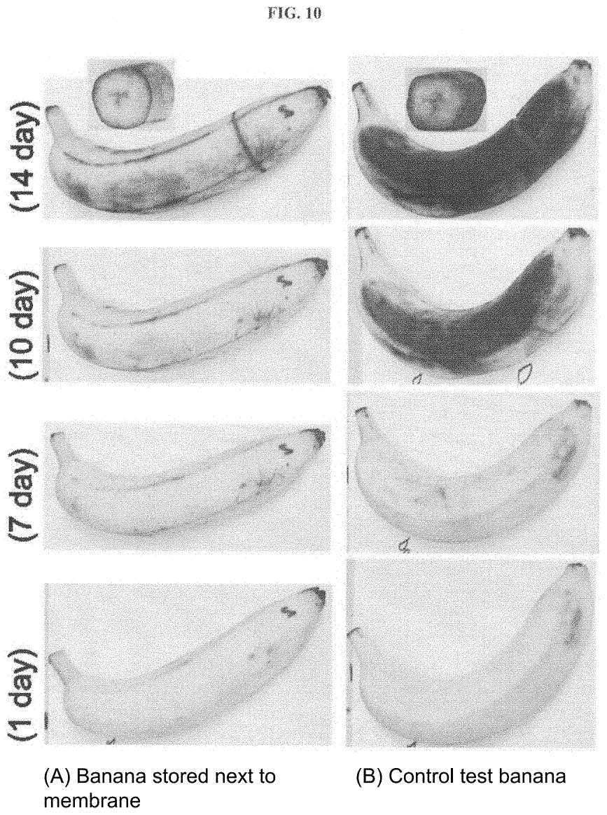

The effect of ethylene absorber membranes to keep fruits fresh was tested by placing bananas in zip-lock bags. Two tests were performed in parallel with bananas placed in separate zip-lock bags. One bag contained 0.7 g of PPM loaded 5% ANP-incorporated alumina nanofiber membrane described above. The 5% ANP incorporated ANF membrane was chosen due to its suitable absorption capacity while possessing more flexibility than its 10% ANP incorporated ANF counterpart. A control test with no absorber in the bag was performed in parallel under the same conditions. Bananas for this test were selected from a single bunch to ensure minimum difference between their initial condition and treatment history. The results shown in FIG. 10 reveal only very minor visual differences between the test and control bananas after 1 day and 7 days. However, after 10 days a dramatic difference is observed between the banana with absorber (FIG. 10A) appearing significantly fresher than the control banana (FIG. 10B) which exhibits a large dark-brown region on its skin. This diversion in the appearance of the two bananas that occurs starting on day 7 can be attributed to a sharp increase in the ethylene production and cellular respiration of bananas as a climacteric fruit.¹ The quality difference is also apparent from the cross-section photos of bananas on day 14 of the test shown in FIG. 10. In fact, the flesh of the banana placed next to the membrane is significantly firmer and has shallower bruising compared to the control test banana. This test demonstrates that fiber membranes according to embodiments may prolong the storage lifetime of products, potentially leading to cost savings associated with delivery, storage and waste disposal of products.

The membranes show significant improvement in ethylene absorption capacity due to their higher surface area with highly micro/nano-porous network compared to conventional approaches, such as alumina beads. Membranes also allow users to choose and customize an absorber based on the application (transportation, storage, etc.). ANP-incorporated carbon nanofibers are ˜15% lighter than ANP incorporated alumina nanofibers which make them a good choice if the weight of carrier is an important consideration, as it is in fruit transportation.

### Comparative Example 3

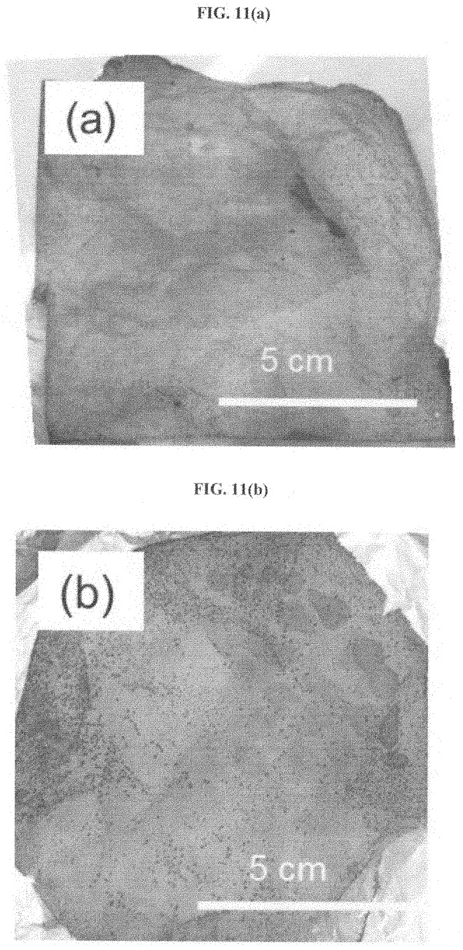

FIGS. 11(a) and 11(b) show, respectively, two membranes made of polyacrylonitrile (PAN) and poly (methyl methacrylate) (PMMA), after loading the membranes with PPM. Both membranes are white before PPM loading, but they turn brown after loading and drying steps, which indicates the PPM has been oxidized and is no longer active. Black spots observed on the membranes are attributed to the aggregation of crystalized PPM clusters that occurs in the drying process. Both PPM loaded membranes do not release any purple color by dipping in deionised water, confirming that no permanganate ion is present in/on the fibers and it has been mostly consumed.

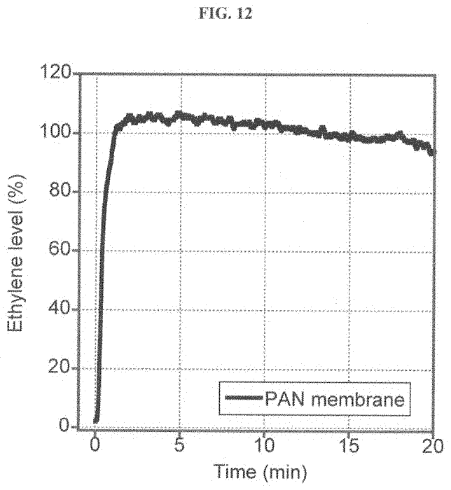

A gas absorption experiment using the same procedure described above with a heavier PAN membrane (PAN 160 mg) of larger size (˜9×9 cm²) loaded with more amount of PPM (˜120 mg PPM) reveals no to very little absorption by the membrane as shown in FIG. 12.

### REFERENCES

References 1-20 are incorporated herein in their entirety.
1. Chervin, C.; El-Kereamy, A.; Roustan, J. P.; Latche, A.; Lamon, J.; Bouzayen, M., Ethylene seems required for the berry development and ripening in grape, a non-climacteric fruit. Plant Science 2004, 167, 1301-1305.
2. Liu, Z. X.; Park, J. N.; Abdi, S. H. R.; Park, S. K.; Park, Y. K.; Lee, C. W., Nano-sized carbon hollow spheres for abatement of ethylene. Topics in Catalysis 2006, 39, 221-226.
3. Bailen, G.; Guillen, F.; Castillo, S.; Serrano, M.; Valero, D.; Martinez-Romero, D., Use of activated carbon inside modified atmosphere packages to maintain tomato fruit quality during cold storage. Journal of Agricultural and Food Chemistry 2006, 54, 2229-2235.
4. Suslow, T., Performance of zeolite based products in ethylene removal. Journal of Physical Chemistry 1997, 101, 3091-3096.
5. Terry, L. A.; Ilkenhans, T.; Poulston, S.; Rowsell, L.; Smith, A. W. J., Development of new palladium-promoted ethylene scavenger. Postharvest Biology and Technology 2007, 45, 214-220.
6. Hussain, M.; Bensaid, S.; Geobaldo, F.; Saracco, G.; Russo, N., Photocatalytic degradation of ethylene emitted by fruits with TiO2 nanoparticles. Industrial & Engineering Chemistry Research 2011, 50, 2536-2543.
7. Wills, R. B. H.; Warton, M. A., Efficacy of potassium permanganate impregnated into alumina beads to reduce atmospheric ethylene. Journal of the American Society for Horticultural Science 2004, 129, 433-438.
8. Magargee, R.; Ahrens, W.; Eyde, D.; Smith, B. Sodium permanganate ethylene absorption agent. US20060070523 A1, 2004.
9. Wiberg, K. B.; Saegebarth, K. A., The Mechanisms of Permanganate Oxidation. IV. Hydroxylation of Olefins and Related Reactions. Journal of the American Chemical Society 1957, 79, 2822-2824.
10. Kim, J. S.; Reneker, D. H., Polybenzimidazole nanofiber produced by electrospinning. Polym Eng Sci 1999, 39, 849-854.
11. Li, D.; Xia, Y., Electrospinning of nanofibers: reinventing the wheel? Advanced Materials 2004, 16, 1151-1170.
12. Agarwal, S.; Greiner, A.; Wendorff, J. H., Electrospinning of manmade and biopolymer nanofibers-progress in techniques, materials, and applications. Advanced Functional Materials 2009, 19, 2863-2879.
13. Han, D.; Steckl, A. J., Superhydrophobic and oleophobic fibers by coaxial electrospinning. Langmuir 2009, 25, 9454-62.
14. Han, D.; Steckl, A. J., Triaxial electrospun nanofiber membranes for controlled dual release of functional molecules. ACS Appl Mater Interfaces 2013, 5, 8241-5.
15. Rajala, J. W.; Shin, H. U.; Lolla, D.; Chase, G. G., Core-shell electrospun hollow aluminum oxide ceramic fibers. Fibers 2015, 3, 450-462.
16. Mitchell, R. R.; Gallant, B. M.; Thompson, C. V.; Shao-Horn, Y., All-carbon-nanofiber electrodes for high-energy rechargeable Li—O-2 batteries. Energy & Environmental Science 2011, 4, 2952-2958.
17. Chen, L. F.; Zhang, X. D.; Liang, H. W.; Kong, M. G.; Guan, Q. F.; Chen, P.; Wu, Z. Y.; Yu, S. H., Synthesis of nitrogen-doped porous carbon nanofibers as an efficient electrode material for supercapacitors. Acs Nano 2012, 6, 7092-7102.
18. Zhao, D.; Wang, T.; Han, D.; Rusinek, C.; Steckl, A. J.; Heineman, W. R., Electrospun carbon nanofiber modified electrodes for stripping voltammetry. Anal Chem 2015, 87, 9315-21.
19. Kim, C.; Yang, K. S., Electrochemical properties of carbon nanofiber web as an electrode for supercapacitor prepared by electrospinning. Applied Physics Letters 2003, 83, 1216-1218.
20. Andreini, A., Re-oxide alumina and re-oxide silica-alumina metathesis catalysts—role of genesis and modification of precursor structures, and lack of activity of the low-loading re-oxide alumina catalyst. Journal of Molecular Catalysis 1991, 65, 359-376.

Although specific exemplary embodiments have been used to describe the invention, it will be appreciated that various modifications, alterations and/or combinations of features disclosed herein will be apparent to those skilled in the art without departing from the scope of the invention as set forth in the following claims.

1. A composite comprising electrospun inorganic fibers and nanoparticles.

2. A composite according to claim 1 wherein the inorganic fibers are carbon nanofibers.

3. A composite according to claim 1 wherein the inorganic fibers are alumina fibers.

4. A composite according to claim 1 wherein the inorganic fibers are carbon fibers.

5. A composite according to claim 1 wherein the nanoparticles are alumina nanoparticles.

6. A composite according to claim 1 wherein the composite is in the form of a film.

7. A composite according to claim 1 a reagent is supported on a surface of the composite.

8. A composite according to claim 1 wherein the reagent is an oxidant.

9. A composite according to claim 1 wherein the reagent is a metal permanganate.

10. A method of absorbing a gas comprising the step of exposing a composite comprising electrospun inorganic fibers and nanoparticles to an environment containing the gas, wherein a gas absorber is supported on the composite.

11. A method according to claim 10 wherein the gas absorber is an oxidant.

12. A method according to claim 11 wherein the gas is an alkene.

13. A method according to claim 12 wherein the gas is ethylene.

14. A method according to claim 13 wherein the environment contains harvested climacteric fruit.

15. A method of forming a composite comprising inorganic fibers and nanoparticles, the method comprising the steps of:
electrospinning an electrospinning composition comprising a precursor material and the nanoparticles to form a precursor composite comprising precursor material fibers and the nanoparticles; and
converting the precursor fibers to the inorganic fibers.

16. A method according to claim 15 wherein the electrospinning composition is an electrospinning solution comprising the precursor material dissolved therein and the nanoparticles dispersed therein to form the precursor composite.

17. A method according to claim 16 wherein the nanoparticles are provided in the electrospinning solution in an amount of up to 20 weight % with respect to the weight of the solvent or solvents of the electrospinning solution.

18. A method according to claim 15 wherein the precursor fibers are converted to the inorganic fibers by heat treatment.

19. A method according to claim 15 wherein the precursor fibers are polymer precursor fibers and the inorganic fibers are carbon fibers.

20. A method according to claim 15 wherein the precursor fibers are fibers of an aluminum salt and the inorganic fibers are alumina fibers.
